(19) United States
(12) Patent Application Publication
(10) Pub. No.: US 2025/0298182 A1
(43) Pub. Date: Sep. 25, 2025

(54) PREFORM FOR MULTICORE OPTICAL FIBERS

(71) Applicant: CORNING INCORPORATED, CORNING, NY (US)

(72) Inventors: Ming-Jun Li, Horseheads, NY (US); Jeffery Scott Stone, Addison, NY (US)

(21) Appl. No.: 19/072,277

(22) Filed: Mar. 6, 2025

Related U.S. Application Data
(60) Provisional application No. 63/567,002, filed on Mar. 19, 2024.

(51) Int. Cl. G02B 6/02; C03B 37/027

(52) U.S. Cl. CPC G02B 6/02042; G02B 6/02395; C03B 37/027

(57) ABSTRACT

A preform for multicore optical fiber is described. The preform includes an assembly of core canes arranged in a desired configuration. The core canes are placed in mutual contact with each other to define a series of contact zones between contacting pairs of core canes. The core canes are fused at selected locations within the contact zones to secure the core canes to form a preform from which a multicore optical fiber can be formed. The preform maintains good alignment of core canes and minimizes deformation of core canes during the fiber draw process. Multicore fibers having excellent uniformity in core diameter are produced from the preforms in conventional fiber draw processes.

This Application claims the benefit of priority to U.S. Provisional Patent Application Ser. No. 63/567,002 filed on Mar. 19, 2024, the content of which is relied upon and incorporated herein by reference in its entirety.

### FIELD

This description pertains to multicore optical fibers. More particularly, this description relates to a preform for multicore optical fibers and drawing of the preform to form multicore optical fibers.

### BACKGROUND

Optical fibers are utilized in a variety of telecommunication applications. The most widely used optical fibers include a single core element for transmission of optical signals. The core element of a single-core optical fiber includes a core region surrounded by one or more cladding regions. Since the transmission capacity of single-core optical fibers is currently approaching its theoretical limits, the demand for increased transmission capacity is currently being met through increases in the number of single-core optical fibers included in transmission cables. While a higher fiber count provides higher transmission capacity, it leads to larger cables and makes it difficult to retrofit existing space-constrained fiber installations with higher capacity cables. As a result, there is a need to develop solutions that provide higher transmission capacity without increasing the size of transmission cables.

One solution under consideration is multicore optical fibers. Multicore optical fibers include multiple core elements embedded in a common cladding. Each core element of a multicore optical fiber acts as an independent signal transmission channel. Since transmission capacity increases as the number of core elements in a multicore fiber increases, it is desirable to maximize the density of core elements in a given cross-sectional area of common cladding.

Multicore optical fibers are drawn from preforms that include multiple core canes positioned within a surrounding cladding. Multicore optical fibers are formed by heating the tip of the preform and drawing fiber from it under tension. As fiber is drawn, it thins in diameter and cools. As the fiber cools, its viscosity increases and the fiber diameter stabilizes to a predetermined target (e.g., 125 microns).

Several methods are currently used to form preforms for multicore optical fibers. In one method, holes are drilled in a cylindrical glass body and core canes are placed into the holes to form a preform. The composition of the glass body corresponds to the composition of the outer cladding regions of the multicore optical fiber drawn from the preform. This method of forming multicore preforms requires an expensive ultrasonic drilling machine to form holes precisely sized with proper smoothness to match the diameter of the core canes. In addition, the length of preforms is limited because it becomes increasingly difficult to maintain uniformity of the holes as the depth of drilling increases.

Another method used to form preforms for multicore optical fibers is the stack-and-draw method. In this method, the core canes and cladding rods are stacked into a round glass substrate tube to form a preform assembly. The cladding rods fill the space between the core canes and the substrate tube and assist in securing the position of the core canes. The preform assembly is then heated under vacuum to close the voids between the core canes, cladding rods, and glass substrate tube. The heating fuses the core canes and cladding rods to each other and to the glass substrate tube to form a solid preform, which is then drawn into multicore optical fiber using a conventional draw tower. However, during the process of fusing the preform assembly, the dimensions and positions of the core canes can be altered, and it becomes difficult to make a multicore optical fiber with uniform sizing and placement of the core regions along the length of a multicore optical fiber.

To solve the problem of precisely positioning core canes, a further method was proposed in which the outer surface of the round core canes is machined into a square shape or other shape with one or more flat surfaces. The flat surfaces of the machined core canes are then contacted or stacked together to form a preform assembly, which is then heated and consolidated to form a multicore preform. While this method may improve alignment and positioning of the core canes in the preform assembly, the initial machining to flatten one or more sides of the core canes adds a costly process step to the manufacture of multicore preforms.

Accordingly, new techniques are required for making preforms and preform assemblies for multicore optical fibers in a cost-effective fashion that provide accurate placement and uniformity of core canes over extended preform lengths.

### SUMMARY

The present disclosure provides preforms and preform assemblies for multicore optical fibers and methods of making the same. The preforms are made by arranging a plurality of core canes in a configuration with contacting outer surfaces to form a preform assembly and fusing the core canes at selected locations along a contact zone defined by the contacting outer surfaces to form fusion regions that secure the core canes to form a preform. The exterior surface of the preform is corrugated. A multicore optical fiber can be drawn from the preform without placing the preform in a substrate tube. Multicore optical fibers drawn from the preforms feature precise and consistent positioning and dimensions of the cores along their length.

The present disclosure extends to:

A preform for optical fibers comprising:
an assembly of a plurality of core canes, the assembly having a first end, a second end, and a central longitudinal axis extending from the first end to the second end, each of the core canes having an outer surface defining a round cross-section, the outer surface of each core cane directly contacting the outer surface of another of the plurality of core canes along a contact zone aligned with the central longitudinal axis, the contact zone including a first fusion region and an unfused region extending from the first fusion region.

The present disclosure extends to:

A multicore optical fiber comprising:
a plurality of core regions spaced apart from one another, the core regions comprising glass
a cladding region surrounding and directly contacting the core regions, the cladding region comprising glass and having a lower relative refractive index than the core regions, the cladding region defining an exterior surface of the multicore optical fiber, the exterior surface being corrugated and lacking corners.

The present disclosure extends to:

A method of making multicore optical fiber comprising:
drawing a multicore optical fiber from a preform, the preform comprising an assembly of a plurality of core canes, the assembly having a first end, a second end, and a central longitudinal axis extending from the first end to the second end, each of the core canes having an outer surface defining a round cross-section, the outer surface of each core cane directly contacting the outer surface of another of the plurality of core canes along a contact zone aligned with the central longitudinal axis, the contact zone including a first fusion region and an unfused region extending from the first fusion region

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale. Whenever possible, the same reference numeral will be used throughout the drawings to refer to the same or like feature.

The claims as set forth below are incorporated into and constitute part of this Detailed Description.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 depicts a cross-sectional view of a core cane having a core region and a cladding region.

FIG. 2 depicts a cross-sectional view of a core cane having a core region, a trench cladding region, and an outer cladding region.

FIG. 3 depicts a cross-sectional view of a core cane having a core region, an offset cladding region, a trench cladding region, and an outer cladding region.

FIG. 4A depicts a relative refractive index profile of a core cane having a core region, a trench cladding region, and an outer cladding region.

FIG. 4B depicts a relative refractive index profile of a core cane having a core region, an offset cladding region, a trench cladding region, and an outer cladding region.

FIG. 5A is a schematic depiction of soot preform deposition via an OVD process.

FIG. 5B depicts an apparatus for doping and consolidating a soot preform.

FIGS. 6A-6C depict deposition of a plurality of soot layers on a substrate.

FIG. 7 depicts a schematic process for forming a multicore optical fiber.

FIG. 8 shows embodiments of preforms for multicore optical fibers that include various assemblies of core canes.

FIG. 9A illustrates an end view of a contacting pair of core canes of a multicore optical fiber preform.

FIGS. 9B and 9C illustrate perspective views of a contacting pair of core canes in a plane containing the centerlines of the contacting pair of core canes.

FIG. 10 depicts a 2×2 arrangement of core canes in a preform for a multicore optical fiber.

FIGS. 11A and 11B show images of the ends of a multicore optical fiber drawn from the preforms depicted in FIG. 10.

FIGS. 12A and 12B show images of the ends of a multicore optical fiber drawn from a preform having a 2×2 configuration of core canes.

FIG. 13 show an image of the end of a multicore optical fiber drawn from a preform having a 2×2 configuration of core canes.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

Disclosed are components (including materials, compounds, compositions, and method steps) that can be used for, in conjunction with, in preparation for, or as embodiments of the disclosed reflecting optical elements and methods for making reflecting optical elements. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. Similarly, if components D, E, and F are individually disclosed, then each combination D-E, E-F, D-F, and D-E-F is also disclosed. This concept applies to all aspects of this disclosure including, but not limited to, components corresponding to materials, compounds, compositions, and steps in methods.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, selection of materials, orientations, etc.) without materially departing from the novel and nonobvious teachings and advantages of the subject matter recited.

In this specification and in the claims which follow, reference will be made to a number of terms which shall be defined to have the following meanings:

“Include,” “includes,” or like terms means encompassing but not limited to, that is, inclusive and not exclusive.

The indefinite article “a” or “an” and its corresponding definite article “the” as used herein means at least one, or one or more, unless specified otherwise.

The term “or,” as used herein, is inclusive; more specifically, the phrase “A or B” means “A, B, or both A and B.” Exclusive “or” is designated herein by terms such as “either A or B” and “one of A or B,” for example.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

The term “about” references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point referred to.

As used herein, “comprising” is an open-ended transitional phrase. A list of elements following the transitional phrase “comprising” is a non-exclusive list, such that elements in addition to those specifically recited in the list may also be present.

The terms “comprising,” and “comprises,” e.g., “A comprises B,” is intended to include as special cases the concepts of “consisting of” and “consisting essentially of” as in “A consists of B” or “A consists essentially of B”.

The term “wherein” is used as an open-ended transitional phrase, to introduce a recitation of a series of characteristics of the structure.

As used herein, “contact” refers to direct contact or indirect contact. Direct contact refers to contact in the absence of an intervening material and indirect contact refers to contact through one or more intervening materials. Elements in direct contact touch each other. Elements in indirect contact do not touch each other but are rigidly or flexibly joined through one or more intervening materials. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other.

“Radial position”, “radius”, or the radial coordinate “r” refers to radial position relative to the centerline (r=0) of the core cane or corresponding core region in a multicore optical fiber drawn from a preform formed from the core cane.

The terms “inner” and “outer” are used to refer to relative values of radial coordinate or relative positions of regions of the core cane or core region in a multicore optical fiber, where “inner” means closer to the centerline of the core cane or core region in a multicore optical fiber than “outer”. An inner radial coordinate is closer to the centerline than an outer radial coordinate. An inner region is closer to the centerline than an outer region.

“Refractive index” refers to the refractive index at a wavelength of 1550 nm.

The “refractive index profile” is the relationship between refractive index or relative refractive index and radius. For relative refractive index profiles depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position within the core region and/or any of the cladding regions. When relative refractive index varies with radial position in a particular region of the core cane or multicore optical fiber (e.g. core region and/or any of the cladding regions), it is expressed in terms of its actual or approximate functional dependence, or its value at a particular position within the region, or in terms of an average value applicable to the region as a whole. Unless otherwise specified, if the relative refractive index of a region (e.g. core region and/or any of the cladding regions) is expressed as a single value or as a parameter (e.g. Δ or Δ % or %) applicable to the region as a whole, it is understood that the relative refractive index in the region is constant, or approximately constant, and corresponds to the single value, or that the single value or parameter represents an average value of a non-constant relative refractive index dependence with radial position in the region. For example, if “i” is a region of the core cane or multicore optical fiber, the parameter Δᵢ refers to the average value of relative refractive index in the region as defined by Δₐᵥₑ given in Eq. (2) below, unless otherwise specified. Whether by design or a consequence of normal manufacturing variability, the dependence of relative refractive index on radial position may be sloped, curved, or otherwise non-constant.

“Relative refractive index,” as used herein, is defined in Eq. (1) for any radial position r as:

$$Δ \% = 100 \frac{( {n}^{2} - {n}_{r e f}^{2} )}{2 {n}^{2}} \qquad ( 1 )$$

where n is the refractive index at the radial position r in the glass fiber, unless otherwise specified and n_{ref} is the refractive index of pure silica glass, unless otherwise specified. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by A (or “delta”) or A % (or “delta %) and its values are given in units of “%”, unless otherwise specified. Relative refractive index may also be expressed as Δ(r) or Δ(r) %. When referring to a specific region i of the core cane or core region of a multicore optical fiber, relative refractive index may also be expressed as A, Δᵢ%, Δᵢ(r) or Δᵢ(r) %.

The average relative refractive index (□ₐᵥₑ) of a region of the fiber is determined from Eq. (2):

$${Δ}_{a v e} = {\int }_{{r}_{i n n e r}}^{{r}_{o u t e r}} \frac{Δ ( r ) d r}{( {r}_{outer} - {r}_{i n n e r} )} \qquad ( 2 )$$

where rᵢₙₙₑᵣ is the inner radius of the region, rₒᵤₜₑᵣ is the outer radius of the region, and Δ(r) is the relative refractive index of the region.

“Trench” or “trench region” or “trench cladding region” refers to the portion of the cladding surrounded by and directly adjacent to the outer cladding region. A trench is situated between the outer radius r₁ of the core region and the inner radius r₃ of the outer cladding region and has a relative refractive index Δ₃ less than the relative refractive index Δ₄ of the outer cladding region. In some embodiments, a trench is directly adjacent to the core region. In other embodiments, an offset cladding region surrounds and is directly adjacent to the core region, and a trench cladding region surrounds and is directly adjacent to the offset cladding region, where the offset cladding region has a relative refractive index Δ₂ less than the relative refractive index Δᵢ of the core region and greater than the relative refractive index Δ₃ of the trench cladding region.

Reference will now be made in detail to illustrative embodiments of the present description.

The present disclosure provides preforms and preform assemblies for multicore optical fibers and methods of making the same. The preforms are made by arranging a plurality of core canes in a configuration with contacting outer surfaces to form a preform assembly and fusing the core canes at selected locations along a contact zone defined by the contacting outer surfaces to form fusion regions that secure the core canes to form a preform. The exterior surface of the assembly and preform is corrugated. Multicore optical fibers drawn from the preforms feature precise and consistent positioning and dimensions of the cores along their length.

Core canes are the constituent elements of the preform assembly. Core canes include a series of two or more concentric glass regions. The concentric glass regions become corresponding regions in multicore optical fibers drawn from the preforms. The core canes include a core region and a cladding region surrounding the core region. The core region and cladding region are glass. The cladding region includes one or more regions that may differ in relative refractive index from the core region and each other. The multiple cladding regions are concentric with respect to each other and the core region. In some embodiments, the cladding region includes a trench cladding region that surrounds the core region. In some embodiments the trench cladding region is surrounded by and directly adjacent to an outer cladding region. In some embodiments, the trench cladding region is directly adjacent to the core region. In other embodiments, the trench cladding region is directly adjacent to an offset cladding region and the offset cladding region is directly adjacent to the core region. The core region, cladding region, trench cladding region, and outer cladding region are also referred to as core, cladding, trench, and outer cladding, respectively. The offset cladding region is optional and may also be referred to herein as an offset.

It is understood that the core region is the central region of the core cane and is substantially cylindrical in shape, and that a surrounding optional offset cladding region, a surrounding trench cladding region, and a surrounding outer cladding region are substantially annular in shape. Annular regions may be characterized in terms of an inner radius and an outer radius. Radial positions r₁, r₂, r₃, and r₄ refer herein to the outermost radii of the core region, offset cladding region, trench cladding region, and outer cladding region, respectively. The radius r₄ corresponds to the outer radius of the core cane.

Whenever used herein, relative refractive index Δ₁ or Δᵢ(r) refer to the core region, relative refractive index Δ₂ or Δ₂(r) refer to the offset cladding region, relative refractive index Δ₃ or Δ₃(r) refer to the trench cladding region, and relative refractive index Δ₄ or Δ₄(r) refer to the outer cladding region. Unless otherwise specified, if a single value is reported for the relative refractive index of a region, the single value corresponds to an average value for the region.

As will be described further hereinbelow, the relative refractive indices of the core region, offset cladding region, trench cladding region, and outer cladding region differ. Each of the regions is formed from doped or undoped silica glass. Variations in refractive index relative to undoped silica glass are accomplished by incorporating updopants or downdopants at levels designed to provide a targeted refractive index or refractive index profile using techniques known to those of skill in the art. Updopants are dopants that increase the refractive index of the glass relative to the undoped glass composition. Downdopants are dopants that decrease the refractive index of the glass relative to the undoped glass composition. In one embodiment, the undoped glass is pure silica glass. When the undoped glass is pure silica glass, updopants include Cl, Br, Ge, Al, P, Ti, Zr, Nb, and Ta, and downdopants include F and B. Regions of constant refractive index may be formed by not doping (e.g., pure silica) or by doping at a uniform concentration. Regions of variable refractive index are formed through non-uniform spatial distributions of dopants and/or through incorporation of different dopants in different regions. Refractive index varies approximately linearly with the concentration of the updopant or downdopant. For example, each 1 wt % Cl as a dopant in silica glass increases the relative refractive index by about 0.083% and each 1 wt % F as a dopant in silica glass decreases the relative refractive index by about 0.32%.

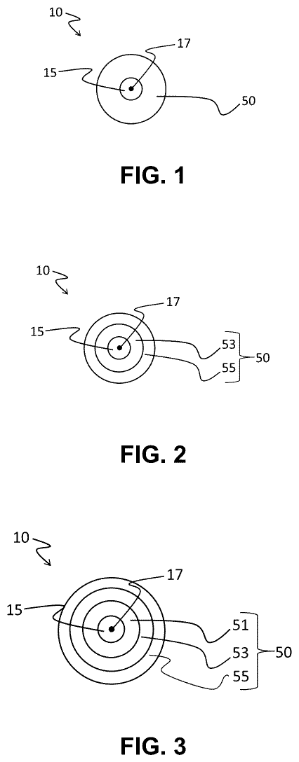

The core canes disclosed herein include a core region and a cladding region surrounding the core region. The core region and cladding region are glass. An example of a core cane is shown in schematic cross-sectional view in FIG. 1. Core cane 10 includes a core region 15 and a cladding region 50. Core region 15 has a higher refractive index than cladding region 50. In embodiments, cladding region 50 is a single region (e.g., outer cladding region) and in other embodiments, cladding region 50 includes multiple concentric regions (e.g., outer cladding region in combination with an offset cladding region and/or trench cladding region). Core cane 10 has a center 17 defining r=0 through which a centerline extending along the length of core cane 10 passes. Core region 15 has a radius r₁ and cladding region 50 has a radius r₄. The ratio of the radius r₁ to the radius r₄ is referred to herein as the “core-clad ratio” and is in the range from 0.10 to 0.60, or in the range from 0.15 to 0.50, or in the range from 0.20 to 0.45, or in the range from 0.25 to 0.40.

Schematic cross-sectional depictions of other embodiments of core cane 10 are shown in FIGS. 2 and 3. In FIG. 2, core cane 10 includes core region 15 and cladding region 50. Cladding region 50 includes trench cladding region 53 and outer cladding region 55. In FIG. 3, core cane 10 includes core region 15 and cladding region 50. Cladding region 50 includes offset cladding region 51, trench cladding region 53, and outer cladding region 55.

In one embodiment (e.g., FIG. 2), the core cane includes a trench cladding region surrounding a core region, and an outer cladding region surrounding the trench cladding region. The trench cladding region is directly adjacent to the core region and the outer cladding region is directly adjacent to the trench cladding region. In another embodiment (e.g., FIG. 3), the core cane includes an offset cladding region surrounding a core region, a trench cladding region surrounding the offset cladding region, and an outer cladding region surrounding the trench cladding region. The offset cladding region is directly adjacent to the core region, the trench cladding region is directly adjacent to the offset cladding region, and the outer cladding region is directly adjacent to the trench cladding region.

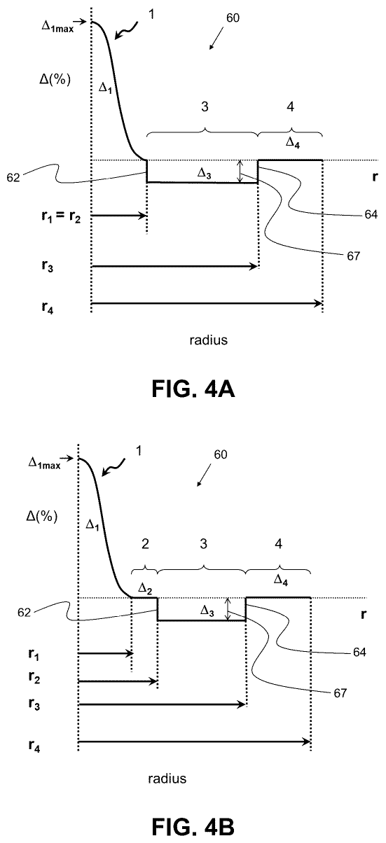

Representative relative refractive index profiles for a core cane are presented in FIGS. 4A and 4B. One type of optical fiber is a step-index optical fiber, which has a core region with a relative refractive index that is constant or approximately constant with radial position from the centerline (r=0). Another type of optical fiber is a graded-index optical fiber, which has a core region with a relative refractive index that varies with radial position from the centerline (r=0) of the optical fiber.

FIG. 4A shows a graded relative refractive index profile for a core cane 60 having a core region (1) with outer radius r₁ and relative refractive index Δ₁ with maximum relative refractive index Δₘₐₓ, a trench cladding region (3) extending from radial position r₂=r₁ to radial position r₃ and having relative refractive index Δ₃, and an outer cladding region (4) extending from radial position r₃ to radial position r₄ and having relative refractive index Δ₄. In the embodiment of FIG. 4A, relative refractive index Δ₃ is constant or approximately constant from inner radius r₂ of the trench cladding region (3) to the outer radius r₃ of the trench cladding region (3).

FIG. 4B shows a graded relative refractive index profile for a core cane 60 having a core region (1) with outer radius r₁ and relative refractive index Δ₁ with maximum relative refractive index Δ₁ₘₐₓ, an offset cladding region (2) extending from radial position r₁ to radial position r₂>r₁ and having relative refractive index Δ₂, a trench cladding region (3) extending from radial position r₂ to radial position r₃ and having relative refractive index Δ₃, and an outer cladding region (4) extending from radial position r₃ to radial position r₄ and having relative refractive index Δ₄. In the embodiment of FIG. 4B, relative refractive index Δ₃ is constant or approximately constant from inner radius r₂ of the trench cladding region (3) to the outer radius r₃ of the trench cladding region (3).

In other embodiments, core region (1) shown in FIGS. 4A and 4B is a step index relative refractive index profile instead of a graded relative refractive index profile. For example, the relative refractive index of the core region may be a step-index profile having a constant or approximately constant value corresponding to Δₜₘₐₓ that extends over at least 70%, or at least 80%, or at least 90% of the distance between the centerline of the optical fiber (r=0) and the outer radius r₁. In further embodiments, trench cladding region (3) shown in FIGS. 4A and 4B has a relative refractive index Δ₃ that varies in the radial direction.

In FIG. 4A, transition region 62 from core region (1) to trench cladding region (3) and transition region 64 from trench cladding region (3) to outer cladding region (4) are shown as step changes. In FIG. 4B, transition region 62 from offset cladding region (2) to trench cladding region (3) and transition region 64 from trench cladding region (3) to outer cladding region (4) are shown as step changes. It is to be understood that a step change is an idealization and that transition region 62 and transition region 64 may not be strictly vertical in practice. Instead, transition region 62 and/or transition region 64 may have a slope or curvature. When transition region 62 and/or transition region 64 are non-vertical, the inner radius (r₂) and outer radius (r₃) of trench cladding region (3) correspond to the mid-points of transition regions 62 and 64, respectively. The mid-points correspond to half of the depth 67 (FIGS. 4A and 4B) of the trench cladding region (3), where depth 67 is defined relative to relative refractive index Δ₄ of the outer cladding region (4).

The relative ordering of relative refractive indices Δ₁, Δ₃, and Δ₄ in the relative refractive index profile shown in FIGS. 4A and 4B satisfy the condition Δ₁ₘₐₓ>Δ₄>Δ₃.

The core region comprises silica glass. The silica glass of the core region is undoped silica glass, updoped silica glass, and/or downdoped silica glass. In one embodiment, the silica glass of the core region is Ge-free; that is the core region comprises silica glass that lacks Ge. In another embodiment, the core region comprises silica glass doped with germanium dioxide (GeO₂). Embodiments of updoped silica glass include silica glass doped with an alkali metal oxide (e.g. Na₂O, K₂O, Li₂O, Cs₂O, or Rb₂O) and/or a halogen (Cl or Br). Downdoped silica glass includes silica glass doped with F.

The outer radius r₄ of the core cane is in the range of 5.0 mm to 30.0 mm. The ratio of the outer radius r₁ of the core region to the outer radius r₄ of the core cane is in the range from 0.10 to 0.50, or in the range from 0.15 to 0.45, or in the range from 0.20 to 0.40. In embodiments, the core region has a graded relative refractive index profile with a relative refractive index Δ₁ or Δ₁ₘₐₓ in the range from 0.20% to 0.50%, or in the range from 0.25% to 0.45%, or in the range from 0.30% to 0.40% and a minimum relative refractive index Δ₁ₘᵢₙ in the range from −0.10% to 0.10%, or in the range from −0.05% to 0.05%, or in the range from −0.02% to 0.02%.

In some embodiments, the cladding includes an offset cladding region directly adjacent the core region and a trench cladding region directly adjacent the offset cladding region. In these embodiments, the offset cladding region has an inner radius r₁ as defined above and an outer radius r₂>r₁. The ratio of the outer radius r₂ of the offset cladding region to the outer radius r₄ of the core cane is in the range from 0.10 to 0.60, or in the range from 0.15 to 0.55, or in the range from 0.20 to 0.50. The ratio of the thickness r₂-r₁ of the offset cladding region to the outer radius r₄ of the core cane is in the range from 0.03 to 0.30, or in the range from 0.05 to 0.25, or in the range from 0.07 to 0.20. The relative refractive index Δ₂ of the offset cladding region is in the range from −0.10% to 0.10%, or in the range from −0.05% to 0.05%, or in the range from −0.02% to 0.02%.

The trench cladding region comprises downdoped silica glass. The preferred downdopant is F (fluorine). The relative refractive index Δ₃ or Δ₃ min of the trench cladding region is greater than −0.70% and/or less than −0.10%, or greater than −0.65% and/or less than −0.15%, or greater than −0.60% and/or less than −0.25%, or greater than −0.55% and/or less than −0.30%.

In some embodiments, the relative refractive index Δ₃ is constant or approximately constant, and in other embodiments, the relative refractive index Δ₃ decreases monotonically from inner radius r₂ to outer radius r₃. In a preferred embodiment, the monotonic decrease in Δ₃ exhibits a constant or approximately constant slope. The monotonic decrease in Δ₃ extends from a maximum value Δ₃ₘₐₓ at or near inner radius r₂ to a minimum value Δ₃ min at or near outer radius r₃. The relative refractive index Δ₃ₘₐₓ is in the range from −0.20% to 0.00%, or in the range from −0.15% to 0.00%, or in the range from −0.10% to 0.00%. In one embodiment, relative refractive index Δ₃ₘₐₓ is equal or approximately equal to the relative refractive index Δ₁ min. In another embodiment, the relative refractive index A₃ₘₐₓ is equal or approximately equal to the relative refractive index Δ₂. The relative refractive index Δ₃ min is in the range from −0.70% to −0.05%, or in the range from −0.60% to −0.10%, or in the range from −0.50% to −0.15% or in the range from −0.40% to −0.20%.

The inner radius of the trench cladding region is r₂=r₁ (in embodiments without an offset cladding region) or r₂>r₁ (in embodiments with an offset cladding region) and has the values specified above. The ratio of the outer radius r₃ of the trench cladding region to the outer radius r₄ of the core cane is in the range from 0.10 to 0.70, or in the range from 0.15 to 0.65, or in the range from 0.20 to 0.60. The ratio of the thickness r₃-r₂ of the trench cladding region to the outer radius r₄ or the core cane is in the range from 0.05 to 0.30, or in the range from 0.07 to 0.25, or in the range from 0.10 to 0.20.

The relative refractive index Δ₄ or Δ₄ₘₐₓ of the outer cladding region is in the range from −0.10% to 0.10%, or in the range from −0.05% to 0.05%, or in the range from −0.02% to 0.02%. The relative refractive index Δ₄ is preferably constant or approximately constant. The inner radius of the outer cladding region is r₃ and has the values specified above. The thickness r₄-r₃ of the outer cladding region to the outer radius r₄ of the core cane is in the range from 0.30 to 0.90, or in the range from 0.35 to 0.85, or in the range from 0.40 to 0.80, or in the range from 0.45 to 0.75.

Multicore optical fibers are drawn from preforms formed as described herein from an assembly of core canes. Core canes are typically formed by redrawing a larger blank consisting of the same concentric regions of the core canes with larger dimensions. Redrawing reduces the size of the blank to the dimensions described herein for core canes. The blank includes a central core region surrounded by an annular cladding region. The composition of the core and cladding regions of the blank correspond to the compositions of the core and cladding regions of core canes redrawn from the blank. The diameter of the core region of the blank and the thickness of the cladding region of the blank are in proportion to the core region diameter and cladding region thickness of core canes drawn from the blank. Preforms for multicore optical fibers are formed from core canes as described hereinbelow. Drawing of the preform produces a multicore optical fiber. Upon draw, each core cane in the preform becomes a core element of a multicore optical fiber. The core region diameter and cladding thickness of core elements are in proportion to the core region diameter and cladding region thickness of the core cane of the preform from which the core element was drawn. The shape of the cross-section defined by the outer surface of the multicore optical fiber is similarly in proportion to the shape of the cross-section defined by the exterior surface of the preform from which the multicore optical fiber was drawn.

Silica and doped silica for the core and cladding regions of a blank from which core canes can be produced by methods known in the art. Suitable methods include flame combustion methods, flame oxidation methods, flame hydrolysis methods, OVD (outside vapor deposition), IVD (inside vapor deposition), VAD (vapor axial deposition), double crucible methods, rod-in-tube procedures, cane-in-soot method, and doped deposited silica processes. A variety of CVD (chemical vapor deposition) and plasma-enhanced CVD processes are known and are suitable for producing silica or doped silica.

Formation of silica occurs through reaction or decomposition of a silica precursor. Suitable precursors for silica include OMCTS (octamethylcyclotetrasiloxane) and SiCl₄. Doping is accomplished with a doping precursor. The doping precursor can be introduced with the silica precursor in the deposition process or used to treat a silica body formed from the silica precursor. Preferred doping precursors include halogen-containing gases. Suitable precursors for doping silica with bromine include SiBr₄. Suitable precursors for doping silica with chlorine include Cl₂, SiCl₄, Si₂Cl₆, Si₂OCl₆, and CCl₄. Suitable precursors for doping silica with fluorine include F₂, CF₄, and SiF₄. The silica precursor and/or doping precursor is preferably provided as a gas to the deposition process. The gas phase silica precursor or gas phase doping precursor is supplied undiluted or in combination with an inert diluent gas (e.g., He, N₂, Ar).

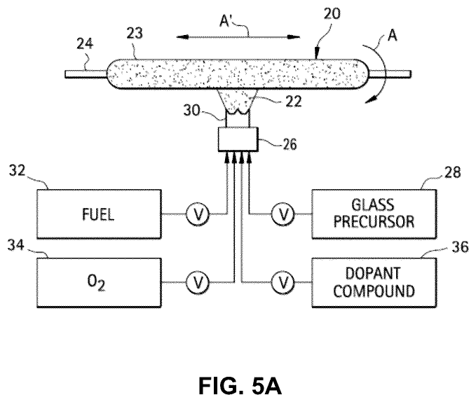

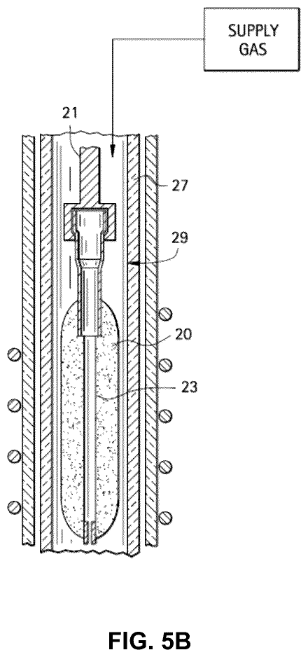

The blank is made by forming the core region and cladding regions in one or more process steps. Typical process steps include soot deposition, doping, and consolidation. By way of illustration and not intended to be limiting, formation of a silica or doped silica in the form of a core soot body according to the OVD method is illustrated in FIGS. 5A and 5B. In FIG. 5A, core soot body 20 is formed by depositing silica-containing soot 22 onto the outer surface of a rotating and translating mandrel 24. Mandrel 24 is preferably tapered. The soot 22 for core soot body 20 is formed by providing a glass/soot precursor 28 in gaseous form to the flame 30 of a burner 26 to oxidize, hydrolyze, combust, or otherwise react or decompose it. Fuel 32, such as methane (CH₄), and a combustion supporting gas 34, such as oxygen, are provided to the burner 26 and ignited to form the flame 30. A dopant compound 36 is also optionally provided to the burner 26. Mass flow controllers, labelled V, meter the appropriate amounts of glass/soot precursor 28, fuel 32, combustion supporting gas 34, and dopant compound 36, all preferably in gaseous form, to the burner 26. The glass/soot precursor 28 is a glass former compound (e.g., silica precursor) and is oxidized in the flame 30 to form a generally cylindrical core soot region 23.

FIG. 5B illustrates another process for doping core soot body 20. Prior to consolidation, the bait rod 24 illustrated in FIG. 5A is removed to form a hollow, cylindrical core soot body. During the doping and consolidation process, the core soot body 20 is suspended, for example, inside a pure quartz muffle tube 27 of the furnace 29 by a holding mechanism 21. Prior to or during the consolidation step, the core soot body 20 is optionally exposed to a doping precursor. The doping precursor is preferably provided in gas-phase form and is supplied directly to core soot body 20 before or during consolidation. In one embodiment, the gas-phase doping precursor is a vapor formed by heating or evaporating a liquid precursor. The doping precursor is supplied neat (undiluted) or in combination with a diluent gas. The doping concentration can be controlled by controlling, without limitation, the temperature of doping, the temperature of vaporization of a liquid doping precursor, the pressure or partial pressure of a gas-phase doping precursor in the processing ambient of the core soot body, time of doping, number of doping cycles, and the porosity or surface area of the core soot body (high porosity and/or high surface area promote higher doping concentrations).

In one embodiment after doping, the core soot body is consolidated to form densified glass with the composition and refractive index profile of the core region of the core cane. Typical temperatures of consolidation are in the range from 1100° C. to 1600° C. The densified glass has a density of at least 1.90 g/cm³. After densification, the densified core glass is optionally redrawn to desired dimensions and is used as a substrate for depositing additional concentric soot layers having the composition and relative refractive index of the cladding regions of the core cane. Alternatively, the additional concentric soot cladding layers can be deposited on the core soot body before consolidation and the combination of layers can be consolidated to form a blank from which core canes are redrawn.

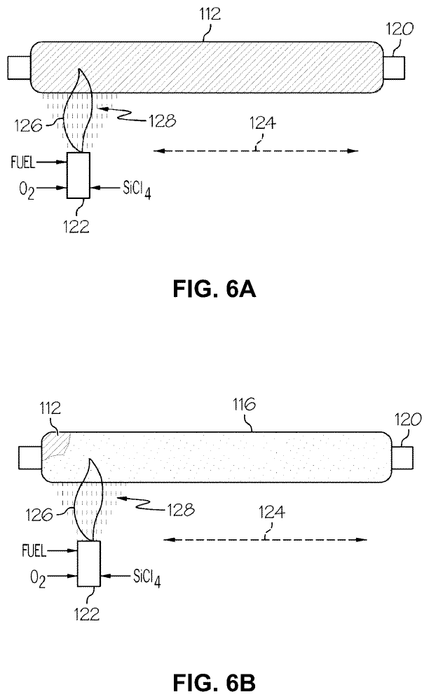

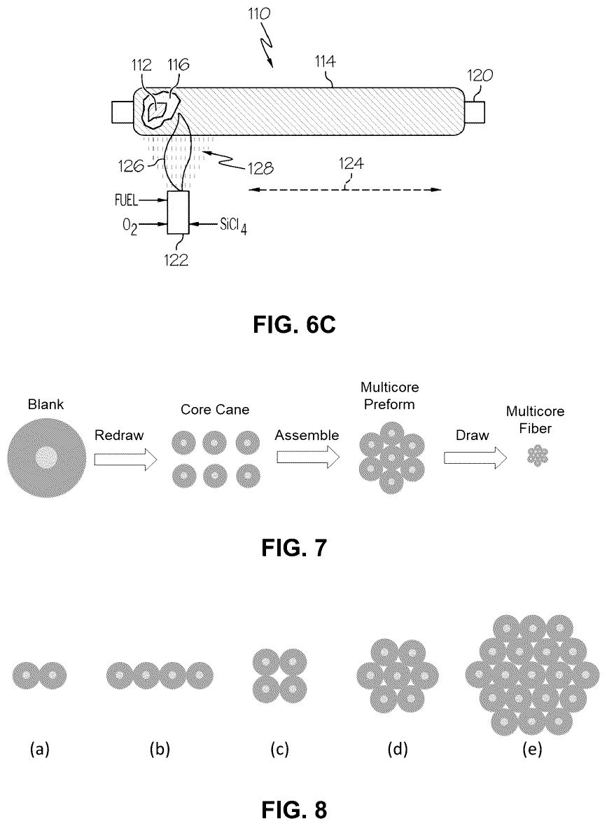

FIGS. 6A-6C illustrate fabrication of a soot body having three porous soot layers. It is recognized, however, that the procedure outlined is generally applicable to a soot bodies having any number of porous soot layers.

FIG. 6A illustrates deposition of a silica-based soot layer 112 on substrate 120. The silica-based glass soot is formed by providing a vapor phase silica-based glass precursor material, such as SiCl₄ or octamethylcyclotetrasiloxane (OMCTS), to a burner 122. The gas-fed burner 122 is supplied with fuel, such as H₂, CH₄, D₂ (deuterium), CD₄ or CO. Oxygen is also provided to burner 122 and the fuel and oxygen are combusted to create flame 126. In some embodiments, the vapor phase silica-based glass precursor material is SiCl₄ and the gas-fed burner 122 is supplied with a non-hydrogenated fuel such as D₂, CD₄ or CO to limit the amount of residual OH in the deposited silica-based glass soot. The vapor phase silica-based glass precursor material may be delivered to the burner at a flow rate from about 4 L/min to about 10 L/min, while the fuel may be supplied to the burner at a flow rate from about 10 L/min to about 40 L/min.

The vapor phase silica-based glass precursor material is reacted in the flame 126 to produce silica-based glass soot 128, which is deposited as soot layer 112 on substrate 120 as the bait rod is rotated. The rotation rate may be from about 20 rpm to about 400 rpm, or preferably from 30 rpm to about 100 rpm. Soot layer 112 may have the same, higher, or lower refractive index than undoped silica. Higher or lower refractive indices may be achieved by supplying an updopant or downdopant precursor to burner 122. Soot layer 112 may constitute a single-layer soot cladding monolith or may constitute the innermost (smallest radius) layer of a multilayer soot cladding monolith. The flame 126 of the gas-fed burner 122 is traversed back and forth along the axial length of the substrate 120 as indicated by arrow 124 as the bait rod is rotated thereby building up silica-based glass soot and forming soot layer 112 on the substrate 120.

FIG. 6B depicts deposition of soot layer 116 on soot layer 112. Soot layer 116 may be formed in a similar manner as soot layer 112. For example, a vapor phase silica-based glass precursor material, such as SiCl₄ or OMCTS, may be supplied to the gas-fed burner 122 and reacted in the flame 126 to form silica-based glass soot which is deposited as soot layer 116 on soot layer 112 as the bait rod is rotated. Soot layer 116 may have the same, higher, or lower refractive index than soot layer 112.

FIG. 6C depicts deposition of soot layer 114 on soot layer 116. Soot layer 114 may be formed in a similar manner as soot layer 112 or soot layer 116. For example, a vapor phase silica-based glass precursor material, such as SiCl₄ or OMCTS, may be supplied to the gas-fed burner 122 and reacted in the flame 126 to form silica-based glass soot which is deposited as soot layer 114 on soot layer 116 as the substrate 120 is rotated. Soot layer 114 may have the same, higher, or lower refractive index than soot layer 116 or soot layer 112. Additional layers of may be deposited similarly to obtain a soot body having any desired number of layers. After deposition of the soot layers, the soot body is consolidated to form a blank from which core canes are redrawn.

Process conditions used to form the different layers of a multilayer soot body may be the same or different. Process variables include flame temperature, flow rates of precursors for silicon or dopants, traversal rate of the burner along the length of the substrate, and rotation rate of the substrate. The dopant concentration can be controlled by varying the flow rate of the dopant precursor, selection of dopant precursor, and temperature of doping. Dopant concentration distributions that are uniform or variable in the radial direction are achievable. To form a trench cladding region with a relative refractive index that decreases monotonically in the radial direction, the concentration of downdoping precursor (e.g., SiF₄) is progressively increased during deposition of the trench cladding layer during soot deposition as the concentric monolayers of trench cladding soot are formed. The flow of downdoping precursor is terminated at the transition from the soot layer corresponding to the trench cladding region to the soot layer corresponding to the outer cladding region. Variations in process conditions can control the deposition rate of soot and density of soot in the as-deposited state. The flame temperature may be 1500° C. or higher. Higher flame temperatures promote higher as-deposited soot density. Conversely, lower flame temperatures lower as-deposited soot density.

In one embodiment, substrate 120 is a consolidated glass having the composition and refractive index of the core region of the core cane to be redrawn from the blank. In this embodiment, the soot layers 112, 116, and 114 correspond to different portions of the cladding region (e.g., offset cladding region, trench cladding region, and outer cladding region). In another embodiment, substrate 120 is a bait rod, soot layer 112 corresponds to the core region, and soot layers 116 and 114 correspond to two different portions of the cladding region (e.g., offset cladding region and trench cladding region, or trench cladding region and outer cladding region). The soot layers, when consolidated, provide a blank configured to permit redraw of core canes having the relative refractive index profiles disclosed herein.

FIG. 7 depicts a process for making a multicore optical fiber from a blank that includes a core region surrounded by a cladding region. Although the cladding region is depicted as a single region, it is understood that the cladding region may include a series of two or more concentric region as described herein in FIGS. 1-4B to produce core canes consistent with the embodiments disclosed herein. In the process, the blank is redrawn to form a plurality of core canes. The plurality of core canes is assembled to form a multicore preform and the multicore preform is drawn to form a multicore optical fiber.

In the redraw process, the blank is stretched and thinned by heating and drawing to form core canes. The blank, or portion thereof, enters a heated zone (e.g., furnace). Heating in the heated zone softens the blank, allowing it to flow, stretch and thin. Tension may be applied to facilitate the redraw. The length of the heated zone or the time at which the blank is at a temperature sufficient to enable it to flow determine the extent of stretching and thinning, and hence the diameter of core canes. The blank is typical a dense glass monolith with a diameter of about 30 mm to 150 mm. Core canes redrawn from the blank have a diameter of about 10 mm to 60 mm. A plurality of core canes is produced by cutting the redrawn blank at lengths of about 1 m to 2 m. The diameter of the core canes is uniform within the plurality. In embodiments, the diameter of each core cane of the plurality is within ±3.0%, or 2.0%, or +1.5%, or +1.0%, or ±0.5% of the mean diameter of the plurality. The outer surface and cross-section of the core canes is round and preferably circular. Deviation from perfect circularity may occur during the redraw process and slight distortions in the cross-section of core canes from circular may occur. Such distortions may, for example, be slightly elliptical. The outer surface and cross-section of the core canes, however, remains round with curvature and lack rectangular features such as corners, vertices, straight sections, or edges. In embodiments, the outer surface defines a cross-section with a radius of curvature greater than 100 microns, or greater than 500 microns, or greater than 1000 microns, or greater than 2000 microns, or greater than 3000 microns, or greater than 5000 microns. When used in reference to a round cross-section, the term “diameter” refers to the average linear dimension of the cross-section passing through the center of the cross-section.

A multicore preform is formed as an assembly of core canes. The core canes of the assembly may be drawn from the same or different blank. An assembly of core canes is formed by placing a plurality of core canes in contact with each other and rigidly joining the core canes. In the assembly, the core canes are arranged in a configuration consistent with the arrangement of core elements desired in the multicore optical fibers to be drawn from the multicore preform. The assembly has a cross-section with a center through which a central longitudinal axis of the assembly passes. In the assembly, the centerlines of the core canes are parallel or approximately parallel to each other and to the central longitudinal axis of the assembly. The outer surface of each core cane is in direct contact with the outer surface of at least one other core cane in a contact zone that extends along the length of the core canes. The contact zone is aligned with the direction of the central longitudinal axis of the assembly. The core canes of the assembly are rigidly joined by fusing at selected locations within the contact zones to form fusion regions that rigidly join the core canes together in the multicore preform. Fusing to form fusion regions occurs by localized heating at selected positions within the contact zone. Localized heating can be accomplished, for example, with a flame torch (e.g., oxyhydrogen flame).

FIG. 8 shows arrangements, in cross-section normal to the central longitudinal axis, of core canes in selected assemblies of core canes that can be used as preforms for multicore optical fibers. Preform (a) includes an assembly of two core canes arranged in a 1×2 linear arrangement. Preform (b) includes an assembly of four core canes arranged in a 1×4 linear arrangement. Preform (c) includes an assembly of four core canes arranged in a 2×2 square arrangement. Preform (d) includes a hexagonal assembly of seven core canes. Preform (e) includes a hexagonal assembly of 19 core canes. It is noted that in the exterior surface of each preform depicted in FIG. 8 is corrugated with undulations, or peaks and valleys, defined by the radius of curvature and arrangement of core canes in the preform. It is also noted that each of the preforms depicted in FIG. 8 lacks a surrounding substrate tube. It is further noted that the preforms (c), (d), and (e) depicted in FIG. 8 each includes one or more internal cavities aligned with the centerlines of the core regions and central longitudinal axis of the assembly and preform. The internal cavities are unfilled regions bounded by the round outer surfaces of the contacting core canes of the assembly. The preforms shown in FIG. 8 are illustrative and not limiting on the number or arrangement of core canes. It will be apparent to those of skill in the art that other arrangements of other numbers of core canes can similarly be envisioned and implemented in accordance with the present disclosure.

In embodiments, the preform assembly includes two or more, or three or more, or four or more, or six or more, or eight or more, or ten or more, or twelve or more core canes arranged in a linear (n×1), or square (n×n), or rectangular (n×m), or hexagonal, or other polygonal configuration.

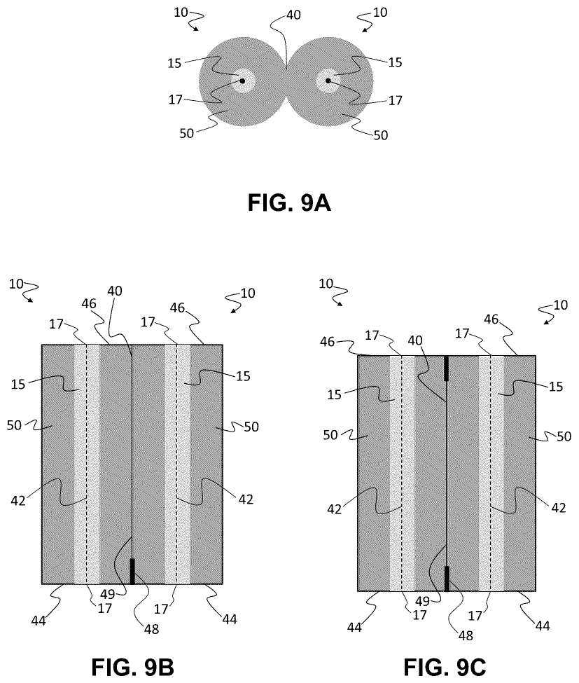

FIGS. 9A and 9B show an enlargement of a contact zone between core canes. FIG. 9A shows a pair of contacting core canes. Although only one pair of core canes is depicted, it is understood that FIG. 9A depicts any pair of contacting core canes in an assembly of core canes in the preforms disclosed herein. Assemblies (b)-(e) in FIG. 8, for example, each contain a plurality of pairs of contacting core canes, each of which is as depicted schematically in FIGS. 9A and 9B. Each core cane 10 depicted FIG. 9A has a center 17, core region 15, and cladding region 50. Centers 17 define respective centerlines extending along the lengths of contacting core canes 10. Also shown is a contact zone 40 along which the outer surfaces of contacting core canes 10 are in contact.

FIG. 9B shows a perspective view of contact zone 40 in a direction parallel to the direction of the centerlines of contacting core canes 10. The perspective view depicted in FIG. 9B corresponds to a plane passing through centers 17 of FIG. 9A and containing the centerlines of contacting core canes 10. For each contacting core cane 10, FIG. 9B shows the core region 15, cladding region 50, and center 17 depicted in FIG. 9A. FIG. 9B further shows a centerline 42, first end 44, and second end 46 for each contacting core cane 10. When assembled into a preform, first end 44 and second end 46 of contacting core canes 10, along with corresponding ends of any other cores canes in the preform assembly, define ends of the preform assembly. The preform assembly includes a central longitudinal axis parallel to centerlines 42 that passes through the center of the preform assembly. If the preform assembly includes only the pair of core canes 10 depicted in FIG. 9B, the central longitudinal axis of the preform assembly would be aligned with contact zone 40.

Contact zone 40 extends from first end 44 to second end 46. In the initial assembly of core canes 10, the outer surfaces are placed in contact and not permanently joined. After initial contact, selected regions of contact zone 40 are fused by heating to permanently join core canes 10. Fusion produces fusion regions 48 at selected locations in contact zone 40. Portions of contact zone 40 not subjected to fusing are unfused regions 49 of contact zone 40. One or more unfused regions 49 extend from each of the fusion regions 48. One or more fusion regions between a pair of contacting core canes in a preform are formed to secure the core canes to each other in the assembly. Fusion occurs by localized heating of the contact zone at the position of the fusion region. Localized heating can be accomplished, for example, with a torch. In one embodiment, fusion regions 48 are formed proximate to an end of the assembly. In another embodiment, fusion regions 48 are formed proximate to both ends of the assembly and an unfused region 49 extends between the fusion regions 48 (FIG. 9C). Preferably, at least one fusion region is formed in the contact zone between each pair of contacting core canes in the assembly. In some embodiments, two or more fusion regions are formed in the contact zones of one or more contacting pairs of core canes in the assembly. In other embodiments, fusion regions are formed away from the ends of the preform assembly such as, for example, toward the middle of contact zone 40.

For purposes of the present disclosure, a fusion region is said to be proximate to an end of the preform assembly if any portion of it is within a distance less than or equal to 25% of the length of contact zone 40 from an end, where the length of contact zone 40 is the distance between first end 44 and second end 46 measured in a direction parallel to centerline 42. In some embodiments, a portion of one or more fusion regions is within a distance less than or equal to 20%, or less than or equal to 15%, or less than or equal to 10%, or less than or equal to 5% of the length of contact zone 40 from an end of the preform assembly. In other embodiments, the entirety of one or more fusion regions is within a distance less than or equal to 20%, or less than or equal to 15%, or less than or equal to 10%, or less than or equal to 5% of the length of contact zone 40 from an end of the preform assembly. In some embodiments, one or more fusion regions extend along contact zone 40 from an end of the preform assembly. The length of the fusion region is less than or equal to 30.0 mm, or less than or equal to 20.0 mm, or less than or equal to 10.0 mm, or less than or equal to 7.0 mm, or less than or equal to 5.0 mm, or greater than or equal to 1.0 mm, or greater than or equal to 3.0 mm, or greater than or equal to 5.0 mm, or. greater than or equal to 10.0 mm, or in the range from 1.0 mm to 30.0 mm, or in the range from 2.0 mm to 20.0 mm, or in the range from 3.0 mm to 15.0 mm,

Once the core canes are arranged and fused, optical fiber is drawn from the preform. In a continuous optical fiber manufacturing process, an optical fiber is drawn from a heated preform positioned in a draw furnace and is passed through a series of processing stages. Processing stages typically include metrology units (e.g. fiber diameter control) to assess quality and other characteristics of the optical fiber, heating stages, a primary coating stage, a secondary coating stage, an ink layer stage, and a spool or other winding stage to receive and store the coated optical fiber. The pathway traversed by the optical fiber as it passes from the draw furnace to the winding stage may be linear or may include turns. The draw speed of the fiber from the preform is greater than 30 m/s, or greater than 35 m/s, or greater than 40 m/s, or greater than 45 m/s, or greater than 50 m/s.

As noted herein, a multicore optical fiber drawn from the preforms of the present disclosure have an exterior surface that is corrugated with undulations and features defined by the dimension and placement of core canes in the assembly of core canes that defines the preform. The cross-sectional dimension of the multicore optical fiber is the largest linear dimension that passes through the center of the cross-section of the multicore optical fiber. Each core region of the multicore optical fiber further has a cross-sectional dimension corresponding to the largest linear dimension passing through its center. In some embodiments, the cross-sectional dimension of the multicore optical fiber is less than or equal to 500 μm, and the cross-sectional dimension of each core of the multicore optical fiber is greater than equal to 50 μm. In other embodiments, the cross-sectional dimension of the multicore optical fiber is less than or equal to 250 μm, and the cross-sectional dimension of each core of the multicore optical fiber is greater than or equal to 60 μm. In one embodiment, the multicore optical fiber drawn from the preform is coated with one or more coatings to form a coated multicore optical fiber having an exterior surface that is round. The round exterior surface lacks corrugation and preferably defines a circular or approximately circular cross-section for the coated multicore optical fiber.

### Example 1

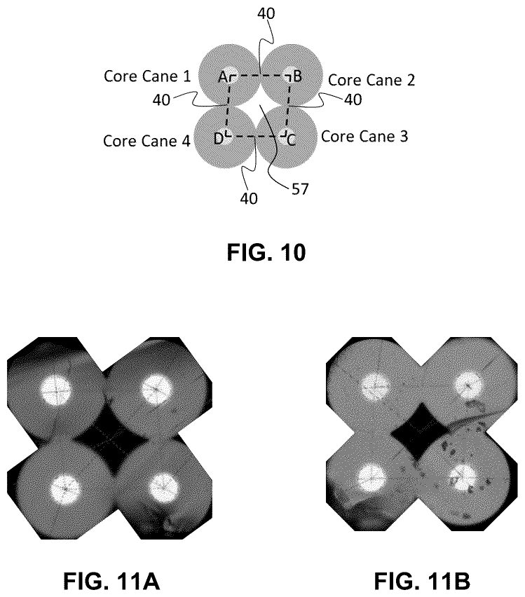

A blank containing a core region surrounded by a cladding region was made by the outside vapor deposition process. The core region was silica glass doped with about 7 weight percent of GeO₂, The cladding region was undoped silica. The blank was redrawn at a temperature of about 1900° C. for with a redraw speed of 10 mm/s, and cut to form core canes with a diameter of 11 mm and a length of 1 m. The core-clad ratio of the core canes was 0.33. Four of the core canes were assembled in an approximate 2×2 square configuration. The approximate 2×2 square assembly is depicted in FIG. 10. Limitations in the alignment system used to form the assembly precluded attainment of a perfectly square configuration. Quadrilateral ABCD connects the centers of the four core canes of the preform. The preform included four contact zones 40 between adjacent core canes of the assembly of core canes. The core canes were secured by forming fusion regions at the top and the bottom of the preform by applying a flame torch for about 30 to 60 seconds. The preform further includes internal cavity 57 enclosed by the core canes. Internal cavity 57 is aligned with the centerlines of the core regions of the core canes and the central longitudinal axis of the preform. The internal cavity 57 extends parallel or approximately parallel to contact zones 40.

A multicore fiber with length 470 m was drawn from the preform. Images of the two ends of the fiber are shown in FIGS. 11A and 11B. The multicore optical fiber has four core regions spaced apart from each other and the core regions are surrounded by a cladding region. The cladding region defines an exterior surface of the multicore optical fiber that is corrugated. An internal cavity along the central longitudinal axis of the fiber is present.

Table 1 compiles measurements of the core region diameter and spacing between cores along quadrilateral ABCD for the preform and the two ends of the fiber.

TABLE 1
Geometry measurements of preform and fiber in Example 1

| | Preform | Fiber | Fiber |
|---|---|---|---|
| | (mm) | End 1 (μm) | End 2 (μm) |
| Core 1 diameter | 3.65 | 20.22 | 20.30 |
| Core 2 diameter | 3.67 | 20.32 | 20.18 |
| Core 3 diameter | 3.57 | 19.94 | 20.03 |
| Core 4 diameter | 3.61 | 19.54 | 19.97 |
| Core spacing AB | 10.88 | 69.41 | 69.21 |
| Core spacing DC | 10.68 | 68.60 | 67.38 |
| Core spacing AD | 10.85 | 68.63 | 68.04 |
| Core spacing BC | 10.89 | 68.27 | 67.31 |
| Core spacing AC | 14.24 | 93.83 | 92.90 |
| Core spacing BD | 16.16 | 100.43 | 99.30 |
| Aspect ratio BD/AC | 1.13 | 1.07 | 1.07 |

The results of Table 1 show similarity in the core diameters and core spacings for the two ends of the fiber. The core diameter variation for the two ends of the fiber was less than 0.45 μm and the core spacing variation for the two ends of the fiber was less than 1.25 μm. The results also show a slight improvement in the aspect ratio of the 2×2 configuration for the fiber relative to the preform.

### Example 2

In a second example, four core canes of the type described in EXAMPLE 1 with were assembled in a 2×2 square configuration using an alignment device to improve the accuracy of the positions of the core canes in the preform.

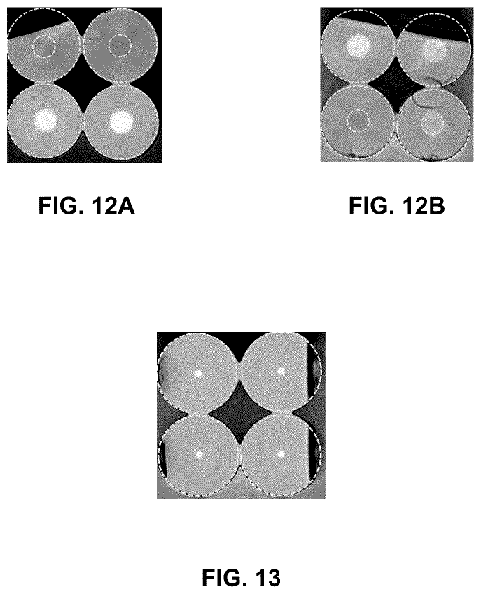

A multicore fiber with length 1050 m was drawn from the preform. Images of the two ends of the fiber are shown in FIGS. 12A and 12B, which shows significant improvement in fiber core geometry arrangement. The multicore optical fiber has four core regions spaced apart from each other and the core regions are surrounded by a cladding region. The cladding region defines an exterior surface of the multicore optical fiber that is corrugated.

Table 2 compiles measurements of the core region diameter and spacing between cores along quadrilateral ABCD for the preform (depicted in FIG. 10) and the two ends of the fiber.

TABLE 2
Geometry measurements of fiber in Example 2

| | Fiber End 1 (μm) | Fiber End 2 (μm) |
|---|---|---|
| Core 1 diameter | 21.05 | 19.84 |
| Core 2 diameter | 21.92 | 20.91 |
| Core 3 diameter | 22.55 | 22.59 |
| Core 4 diameter | 22.67 | 23.46 |
| Core spacing AB | 77.93 | 78.91 |
| Core spacing DC | 77.95 | 78.73 |
| Core spacing AD | 79.41 | 79.17 |
| Core spacing BC | 76.96 | 78.48 |

The results of Table 2 show similarity in the core diameters and core spacings for the two ends of the fiber. The core diameter variation for the two ends of the fiber was less than 1.25 μm and the core spacing variation for the two ends of the fiber was less than 1.52 μm over about 1 km length.

### Example 3

In a third example, four core canes with a diameter of 11 mm were assembled in a 2×2 square configuration using an alignment device. The core canes were similar to those of EXAMPLES 1 and 3, but had smaller a smaller radius of the core region to achieve single mode cores in fiber drawn from the preform.

A multicore fiber with length 2050 m was drawn from the preform. Images of one end of the fiber are shown in FIG. 13. The multicore optical fiber has four core regions spaced apart from each other and the core regions are surrounded by a cladding region. The cladding region defines an exterior surface of the multicore optical fiber that is corrugated.

Table 3 shows measurements of the core region diameter and spacing between cores along quadrilateral ABCD for the preform (depicted in FIG. 10) and the two ends of the fiber.

TABLE 4
Geometry measurements of fiber in Example 3

| | Fiber End 1 (μm) |
|---|---|
| Core 1 diameter | 8.48 |
| Core 2 diameter | 8.44 |
| Core 3 diameter | 8.52 |
| Core 4 diameter | 8.72 |
| Core spacing AB | 105.0 |
| Core spacing DC | 106.0 |
| Core spacing AD | 107.1 |
| Core spacing BC | 107.0 |

Measurements of the mode filed diameter (MFD) at 1310 nm and 1550 nm, fiber cutoff wavelength, and attenuation at 1310 nm and 1550 nm were completed for each of the four cores of the multicore optical fiber. The results are summarized in Table 4. The MFD, fiber cutoff wavelength and attenuation for each of the core regions of the multicore optical fiber were in compliance with industry standards for single mode fiber.

TABLE 4
Optical measurements of fiber in Example 3

| | MFD (μm) | | | Attenuation (dB/km) | |
|---|---|---|---|---|---|
| | 1310 nm | 1550 nm | Cutoff (nm) | 1310 nm | 1550 nm |
| Core 1 | 9.7 | 11.2 | 1178 | 0.391 | 0.276 |
| Core 2 | 9.6 | 11.1 | 1220 | 0.364 | 0.271 |
| Core 3 | 9.7 | 11.1 | 1178 | 0.385 | 0.280 |
| Core 4 | 9.9 | 11.7 | 1174 | 0.367 | 0.263 |

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations, and variations of the disclosed embodiments that incorporate the spirit and substance of the illustrated embodiments may occur to persons skilled in the art, the description should be construed to include everything within the scope of the appended claims and their equivalents.

What is claimed is:

1. A preform for multicore optical fibers comprising:
an assembly of a plurality of core canes, the assembly having a first end, a second end, and a central longitudinal axis extending from the first end to the second end, each of the core canes having an outer surface defining a round cross-section, the outer surface of each core cane directly contacting the outer surface of another of the plurality of core canes along a contact zone aligned with the central longitudinal axis, the contact zone including a first fusion region and an unfused region extending from the first fusion region.

2. The preform of claim 1, wherein the assembly comprises three or more of the core canes.

3. The preform of claim 1, wherein the core canes are arranged in a linear configuration, a square configuration, a rectangular configuration, or a hexagonal configuration.

4. The preform of claim 1, wherein the round cross-section has a radius of curvature greater than 1000 microns.

5. The preform of claim 1, wherein each of the core canes comprises a core region and a cladding region, the cladding region surrounding and directly adjacent to the core region, the core region having a relative refractive index greater than the relative refractive index of the cladding region.

6. The preform of claim 5, wherein the cladding region comprises a trench cladding region.

7. The preform of claim 1, wherein the preform comprises one or more internal cavities aligned with the central longitudinal axis.

8. The preform of claim 1, wherein the first fusion region is proximate to the first end of the assembly.

9. The preform of claim 8, wherein the entirety of the first fusion region is proximate to the first end of the assembly.

10. The preform of claim 1, further wherein the contact zone further includes a second fusion region.

11. The preform of claim 10, wherein the second fusion region is proximate the second end of the assembly.

12. The preform of claim 1, wherein the preform has an exterior surface that is corrugated.

13. The preform of claim 12, wherein the exterior surface lacks corners.

14. A multicore optical fiber comprising:
a plurality of core regions spaced apart from one another, the core regions comprising glass;
a cladding region surrounding and directly contacting the core regions, the cladding region comprising glass and having a lower relative refractive index than the core regions, the cladding region defining an exterior surface of the multicore optical fiber, the exterior surface being corrugated and lacking corners.

15. The multicore optical fiber of claim 14, wherein the exterior surface further lacks straight sections.

16. The multicore optical fiber of claim 14, further comprising a coating, the coating having a round outer surface.

17. The multicore optical fiber of claim 14, wherein the cross-sectional dimension of the multicore optical fiber is less than 500 μm and the cross-sectional dimension of each core region of the multicore optical fiber is greater than 50 μm.

18. The multicore optical fiber of claim 14, wherein the plurality comprises three or more of the core regions.

19. The multicore optical fiber of claim 14, wherein the core regions are arranged in a linear configuration, a square configuration, a rectangular configuration, or a hexagonal configuration.

20. A method of making multicore optical fiber comprising:
drawing a multicore optical fiber from a preform, the preform comprising an assembly of a plurality of core canes, the assembly having a first end, a second end, and a central longitudinal axis extending from the first end to the second end, each of the core canes having an outer surface defining a round cross-section, the outer surface of each core cane directly contacting the outer surface of another of the plurality of core canes along a contact zone aligned with the central longitudinal axis, the contact zone including a first fusion region and an unfused region extending from the first fusion region.
